(19) United States
(12) Patent Application Publication
(10) Pub. No.: US 2010/0214892 A1
(43) Pub. Date: Aug. 26, 2010

(54) OPTICAL RECORDING DEVICE AND METHOD OF OPERATING AN OPTICAL RECORDING DEVICE

(75) Inventors: Edgar Martinus Van Gool, Eindhoven (NL); Gary Maul, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,509

(22) PCT Filed: Nov. 27, 2006
(86) PCT No.: PCT/IB2006/054461

§ 371 Date: May 30, 2008

(30) Foreign Application Priority Data
Dec. 1, 2005 (EP) 05111580.6

(51) Int. Cl. G11B 7/00

(52) U.S. Cl. 369/53.2; G9B/7

(57) ABSTRACT

The position of a write spot on an optical record carrier, during a write operation by an optical recording device, is important for the quality of the data recorded. Radial positioning of the spot may be facilitated by means of tracking spots, signals from which identify the location of the write spot. Signals from the tracking spots may be affected by the characteristics of the optical record carrier in the their vicinity. Specifically, effects arise from the recorded or unrecorded nature of the tracks adjacent each spot. The invention comprises rotation of the means to generate tracking spots such that tracking spots may be placed in an optimum position for recording, regardless of which data layer on an optical record carrier is to be recorded or the recording direction.

### FIELD OF THE INVENTION

The invention relates to the field of optical recording devices, more particularly to the recording function and the positioning of the write spot during recording operations, and a method of operating an optical recording device for recording operations. Further, the invention relates to an optical recording device, for recording data on an optical record carrier comprising at least two layers comprising tracks for recording the data, the optical recording device comprising a light beam, and further comprising a means to generate tracking spots from the light beam to aid positioning of a write spot used to record data on the optical record carrier.

### BACKGROUND OF THE INVENTION

Optical recording devices are widely known. Such devices use light, in the form of a focused spot, to read or write data from an optical record carrier, which may comprise one or more data layers. Trends towards the storage of increasing amounts of data on optical record carriers has lead to an increase in complexity of the optical recording devices and tighter tolerances in the operation of the devices.

Optical recording devices, their operation for read and write functions, the control mechanics associated with the hardware, and information on some types of media for optical record carriers, are found in “Principles of Optical Disc Systems” by G. Bouwhuis et al, ISBN 0-85274-785-3, Pub. Adam Hilger Ltd. In particular, this book discusses the servo systems, which assure radial and vertical tracking of the information on the optical record carrier by the optical recording device. Further information is provided on optical record carrier devices. It has been standard that optical record carriers comprise one layer on to which data may be written or from which data may be read. Current trends also include optical record carriers with two or more data layers.

Additional information on optical recording devices, especially optical heads and radial servo mechanisms is found in “Optical Heads” by J. Schleipen et al, Encyclopaedia of Optical Engineering DOI: 10.1081/E-EOE 120009664 (2003), Pub. Marcel Dekker, Inc.

One method mentioned for radial tracking is the push-pull method, which involves generation of satellite tracking spots, usually by means of diffraction of light into different diffracted orders. Information from the tracking spots is processed and combined with the tracking information from the main spot itself in order to control the location of a main write spot (used to record information on an optical record carrier). Alternatively, only information from the tracking spots are processed to give a location of the write spot, especially with respect to tracks on the optical record carrier. A main spot should be positioned coincident with a track on the optical record carrier to allow data to be written on the track. Usually two tracking spots are then arranged, relative to the main spot, on each side of the track. In an ideal situation, the tracking spots are located halfway between the track to be recorded and its next neighbor, on each side of the track to be recorded. Signals from each satellite spot are compared and processed. The difference from an ideal signal indicates a location removed from the ideal position. This information can then be fed back to adjust the main spot to a better radial position on the disc.

A problem with the known system is that offsets in the tracking signals, arising from cross talk in the fed back signals due to adjacent tracks on the optical record carrier, may become unbalanced, depending on the characteristics of the tracks of the optical record carrier, thereby leading to errors in the radial spot position.

### SUMMARY OF THE INVENTION

It is an object of the invention to provide an optical recording device in which the error in a determination of radial spot position on an optical record carrier is reduced.

This object is achieved according to the invention in that the means to generate tracking spots is arranged to cooperate with a means for rotation such that the means to generate tracking spots is rotatable between at least two positions to achieve optimum orientation of tracking spots, such that each tracking spot is positioned between two neighboring tracks on the optical record carrier and is either adjacent on two sides to recorded tracks or adjacent on two sides to unrecorded tracks, for each layer to be recorded.

Offsets in the push pull signal originate from lack of symmetry in the immediate environment of a tracking spot. The offset value also depends on the writing power used during a write process, because when using larger write powers, the tracks are recorded with more contrast and the offset in the push pull signals of the tracking spots can be more severe. If the symmetry is restored, the offset is reduced. Symmetry is restored by placing a spot such that tracks on each side of the spot are both recorded or both unrecorded.

Tracks on an optical record carrier are arranged in a planar layer and follow a spiral which runs in a loop of ever increasing radius from the inside of the optical record carrier to the outside of the disc. Data may be written to the optical record carrier following this spiral from the inside or from the outside. For optical record carriers comprising more than one data layer, it is most efficient to swap the direction of following the spirals between layers. That is, if the first layer is written following a spiral running from the inside of the optical record carrier towards the outside, the write process for next layer will start at the outside of the optical record carrier and follow its spiral inwards, and visa versa. This, however, results in a tracking spot set-up, which is only efficient for one of the two layers. For the second layer, offsets will be created in the tracking signals and errors in radial positioning of the write spot will be created.

The tracking spots are generated by a component or components in the optical recording device which produce tracking spots in a certain alignment to the track on which data is written. This alignment is then changed for the optimum alignment to a second data layer written to along the spiral in a different direction to the first layer. Rotation of the component or components generating the tracking spots, before recording on the next data layer, allows each layer to have an optimum alignment. Thus the radial tracking signal is improved.

In a further embodiment of the invention, the means to generate tracking spots comprises a grating.

In a further embodiment of the invention, the grating is a three beam grating which produces three spots of light, namely one main spot and two satellite spots.

Gratings are an efficient way of producing tracking spots, and a main spot. The ratio of light intensity between the orders and the spread of the diffraction can be controlled depending on the grating design.

In a further embodiment of the invention, the means to generate tracking spots forms part of a push pull tracking system.

The push-pull tracking system operation is sensitive to the signals from the spots and particularly to differences and asymmetries, thereby making it a good choice for association with the invention.

In a further embodiment of the invention, the means for rotation comprises a motor.

In a further embodiment of the invention, the means for rotation comprises a piezo element.

The means to generate tracking spots can be rotated using a mechanism, examples of which comprise a motor and a piezo element. The rotation can be realized with a motor or piezo element, located inside the optical pick-up unit (OPU) in the optical recording device, which rotates the grating or other component used to produce tracking spots. The rotation can be calibrated in the OPU factory on a calibration disc. (Alternatively the tracking spots can also be adjusted by observing the spots produced from the OPU and adjusting them to certain angle—although this latter method will be less accurate). The pre-stored settings can be recalled in the pickup when switching recording from one layer to another or when setting up for a particular chosen layer. The time needed for rotating the grating can be compensated using the data-buffer already available inside typical optical recording devices.

In a further embodiment of the invention, there is provided a method of operating an optical recording device, in cooperation with an optical record carrier comprising at least two layers on which data may be recorded along tracks, comprising steps of:
Providing a means to generate tracking spots, arranged to cooperate with a means for rotation, such that the means to generate tracking spots is rotatable between at least two positions,
Operating the optical recording device in write mode to record data on a data layer,
If recording on a layer 1, positioning the means to generate tracking spots in accordance with an operation of writing data to a data layer, such that each tracking spot is positioned between two neighboring tracks on the optical record carrier, and is either adjacent on two sides to recorded tracks or adjacent on two sides to unrecorded tracks, and thereby giving at least a leading spot and a trailing spot with respect to a main write spot,
If recording on a layer 2, rotating of the means to generate tracking spots by the means for rotation to adjust the tracking spot position and is either adjacent on two sides to recorded tracks or adjacent on two sides to unrecorded tracks, and thereby giving at least a leading spot and a trailing spot with respect to the main write spot, such that the orientation of the leading spot for recording on layer 1 becomes the trailing spot for recording on layer 2 and visa versa, or,

if recording on layer 2, rotating of the means to generate tracking spots by the means for rotation to adjust the tracking spot position and is either adjacent on two sides to recorded tracks or adjacent on two sides to unrecorded tracks, and thereby giving at least a leading spot and a trailing spot with respect to the main write spot, such that the leading spot for recording on layer 1 remains the leading spot for recording on layer 2, and the trailing spot for recording on layer 1 remains the trailing spot for recording on layer 2.

This method allows all data layers on an optical record carrier, regardless of tracking direction, to be tracked and written to with the same level of radial tracking quality.

In a further embodiment of the invention, the method described above comprises the additional step of:
Rotating the means to generate tracking spots by an amount determined by pre-stored settings obtained from calibration during manufacture.

This method allows standardization of calibration across many optical recording devices.

A method for initial programming of an optical recording device comprising an optical pickup unit (OPU) comprising steps of:
Provision of a means to generate tracking spots arranged in cooperation with a means of rotation such that the means to generate tracking spots is rotatable between at least two positions,
Provision of a calibration source comprising at least one pre-determined setting for amount of rotation to be applied to the means of rotation,
Incorporation of the at least one pre-determined setting for amount of rotation into a non-volatile memory of the OPU or other memory component of the optical recording device.

This method allows standard rotation calibrations to be performed in a mass—production environment.

### BRIEF DESCRIPTION OF THE DRAWINGS

FIG. 1 shows optimal tracking spot positions during a write operation on an optical record carrier, the data being written from the inside radius of the spiral track outwards, which result in minimal radial offset in the individual push pull signals of the tracking spots.

FIG. 2 shows poor tracking spot positions during a write operation on an optical record carrier, the data being written from the inside radius of the spiral track outwards, which result in unwanted radial offsets in the individual push pull signals of the tracking spots.

FIG. 3 shows the non-optimum positioning of tracking spots during a write operation on an optical record carrier, the data being written from the outside radius of the spiral track inwards i.e. in the reverse direction to that shown in FIGS. 1 and 2, which results in unwanted radial offsets in the individual push pull signal of the tracking spots.

FIG. 4 shows the improvement in tracking spot position, during a write operation on an optical record carrier, the data being written from the outside radius of the spiral track inwards i.e. in the reverse direction to that shown in FIGS. 1 and 2, when the tracking spots are rotated according to the invention and are thus aligned to produce minimal radial offset in the individual push pull signal of the tracking spots.

FIG. 5 shows a method of operating an optical recording device according to the invention.

FIG. 6 shows a method of operating an optical recording device according to the invention.

FIG. 7 shows a method for initial programming of an optical recording device according to the invention.

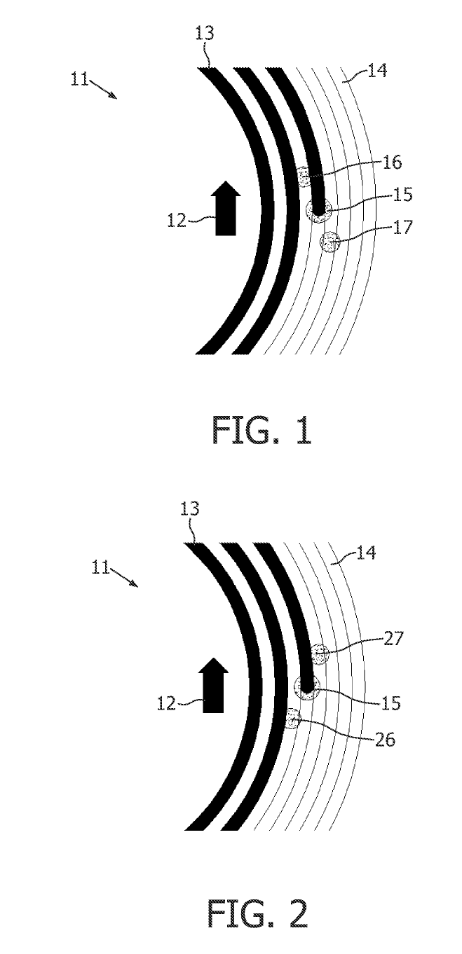

FIG. 1 shows a section of an optical record carrier 11 spinning in a direction indicated by the arrow 12 during a write process of an optical recording device (not shown). In this case, the data is being written from an inside radius of the spiral track to an outside radius. Parts of the spiral track designed to hold written data are illustrated, parts of the track already recorded being shown as black 13 and unrecorded parts of the track being shown as white 14. Recording of data takes place via a write spot of light 15. On each side of the write spot 15 are positioned tracking spots 16 and 17. Tracking spot 16, lagging behind the write spot 15, is adjacent on two sides by recorded track while the other tracking spot 17, in advance of the write spot 15, is adjacent on two sides to unrecorded track. The symmetry of the recorded 13/unrecorded 14 tracks adjacent each tracking spot 16,17 balances the push pull signal returned to the system for radial tracking (not shown) of the write spot 15, thereby permitting a good determination of the location of the write spot 15.

FIG. 2 shows an alternative arrangement of tracking spots for the same optical record carrier and recording direction as described in FIG. 1 (where features are the same as FIG. 1, the numbering is kept consistent). In FIG. 2 the spot in advance of the write spot 15 is now tracking spot 26 and the lagging tracking spot is 27. Note the characteristics of the tracks adjacent the tracking spots 26 and 27. Each tracking spot 26,27 has unrecorded track 14 on one side and recorded track 13 on the other. Such a situation initiates asymmetries in the tracking spot signals returned to the system for radial tracking (not shown) of the write spot 15. The offsets induced in the push-pull signal deteriorate the quality of radial tracking for the write process.

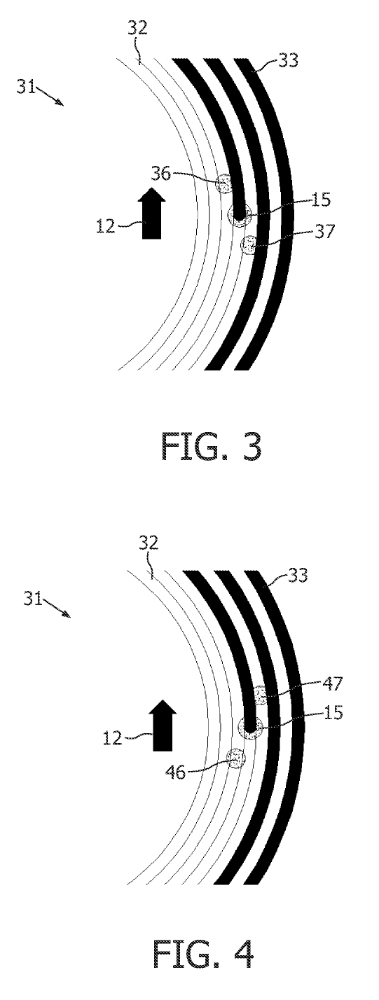

FIG. 3 illustrates the relative positioning of tracking spots and tracks for an optical record carrier 31. The optical record carrier again spins in a direction indicated by arrow 12 during a write process. This optical record carrier has a layer for storage of data but, unlike the previous cases, the recording is performed on the track starting from an outside radius and moving inwards towards an inside radius. Thus recorded track regions 33, again shown as black, are on the outside of the optical record carrier 31, and unrecorded track regions 32, again shown as white, are towards the inside. The tracking spots 36 and 37 are positioned in the same orientation with respect to the optical record carrier as was the case in FIG. 1. Now that the direction of recording has been switched, the tracking spots are no longer optimally placed with respect to recorded 33/unrecorded 32 tracks. This has the same effect as that described for FIG. 2. Such a situation initiates asymmetries in the tracking spot signals returned to the system for radial tracking (not shown) of the write spot 15. The offsets induced in the push-pull measurement deteriorate the quality of radial tracking for the write process. (Note that the optical record carrier 31 could also be taken to represent a second layer of optical record carrier 11, where recording on different tracks is done in alternate directions).

FIG. 1 shows an optimum set-up of tracking spots according to the characteristics of surrounding tracks. FIGS. 2 and 3 illustrate how it is possible for the signals obtained from tracking spots to be compromised by non-optimum set-up of tracking spots, sometimes due to operational requirements of the optical recording device or use of optical record carriers comprising multiple data layers.

FIG. 4 shows a result of applying the invention for circumstances which in prior art lead to non-optimum tracking spot placement. As an example, the optical record carrier 31 and write mode operation are explained here with reference to the recording operation detailed in FIG. 3. Within an optical recording device (not shown) there is a means to generate the tracking spots (not shown) used for radial tracking of the write spot 15 on an optical record carrier 31. The invention applied to circumstances shown in FIG. 3 comprises the rotation of the means to generate the tracking spots.

In one embodiment of the invention, the tracking spots 36 and 37 are rotated into a new position illustrated by tracking spots 46 and 47, respectively. In an alternative embodiment of the invention a smaller rotation is utilized such that tracking spots 36 and 37 would have a new position illustrated by tracking spots 47 and 46, respectively. The result of a rotation according to either embodiment of the invention is that both tracking spots 46 and 47 are placed such that the symmetry of the recorded 33/unrecorded 32 tracks adjacent each tracking spot 46,47 balances the push pull signal returned to the system for radial tracking (not shown) of the write spot 15, thereby permitting a good determination of the location of the write spot 15.

The invention has been illustrated in FIG. 4 as a change in position, by rotation of a hardware element, from one state (shown in FIG. 3) to another state (shown in FIG. 4), which results in a change of position of tracking spots on an optical record carrier. These rotations or positions may be calibrated for a system, pre-stored in memory, set-up in the factory, etc. but are not necessarily limited to two positions only.

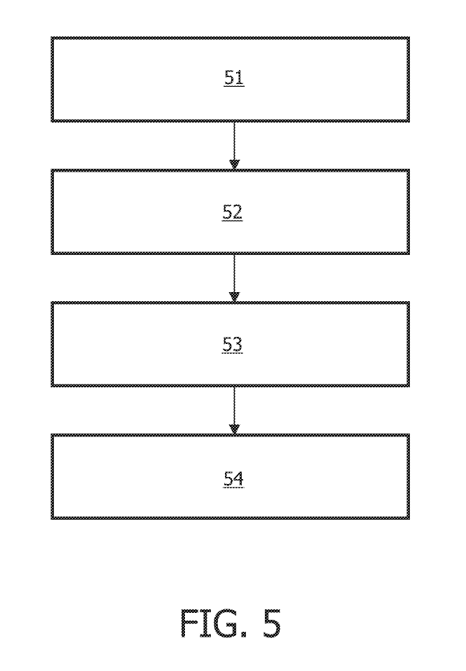

FIG. 5 illustrates a method of operating an optical recording device according to the invention. The optical recording device is arranged to cooperate with an optical record carrier, in order to write data to the optical record carrier for example.

The optical recording device is provided with a means to generate tracking spots, arranged to cooperate with a means for rotation, such that the means to generate tracking spots is rotatable between at least two positions 51. This allows tracking spots to be placed flexibly and optimally on the optical record carrier such that a tracking spot is between recorded tracks or unrecorded tracks and not placed such that a spot has recorded track on one side and unrecorded track on the other. In this way symmetry in the push-pull signal used to control radial tracking of a write spot on the optical record carrier is maintained, offsets are avoided and the quality of the information is not deteriorated.

In a next step of the method 52, the optical recording device is operated in write mode to record data on a data layer of the optical record carrier. An optical record carrier may have one or more layers, but in this example an optical record carrier with two layers is used to illustrate the invention. Data is recorded on one layer at a time.

According to a next method step 53, if recording on a layer 1, the means to generate tracking spots is positioned in accordance with an operation of writing data to a data layer, such that each tracking spot is positioned between two neighboring tracks on the optical record carrier, and is either adjacent on two sides to recorded tracks or adjacent on two sides to unrecorded tracks, and thereby giving at least a leading spot and a trailing spot with respect to a main write spot. The symmetry in the signals returned to the mechanism for controlling the position of the write spot is optimum for such an arrangement.

According to another method step 54, if recording on a layer 2, the means to generate tracking spots should be rotated by the means for rotation to adjust the tracking spot position and is either adjacent on two sides to recorded tracks or adjacent on two sides to unrecorded tracks, and thereby giving at least a leading spot and a trailing spot with respect to a main write spot. In one embodiment of the invention, the rotation is such that the orientation of the leading spot for recording on layer 1 becomes the trailing spot for recording on layer 2 and visa versa. In another embodiment of the invention, the leading spot for recording on layer 1 remains the leading spot for recording on layer 2 and the trailing spot for recording on layer 1 remains the trailing spot for recording on layer 2. If no rotation occurred (as in prior art), the tracking spot position which had been optimum for layer 1 would remain the same relative to the optical record carrier. In operation of the optical recording device, however, use of layer 2 would alter the optimum tracking spot position, thus the used tracking spot positions on layer 2 would be poor. The rotation of the tracking spots by rotation of the means to generate those spots, according to the invention, allows tracking spots to be placed optimally on the optical record carrier for all layers.

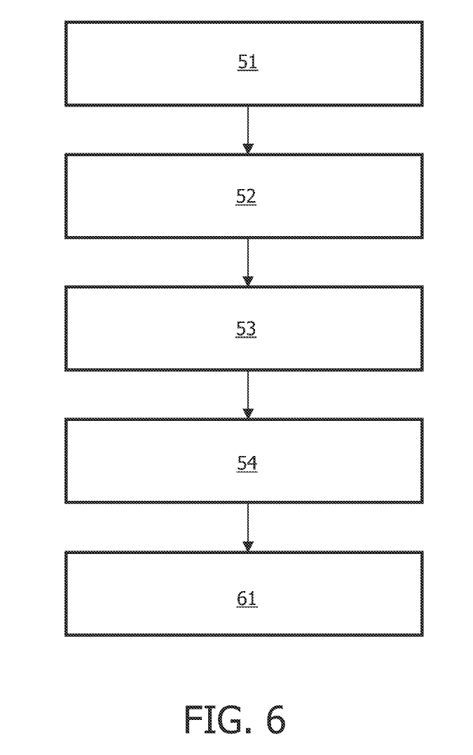

FIG. 6 illustrates a method of operating an optical recording device according to the invention which comprises all the steps of the method outlined in FIG. 5 and includes an additional step 61. This additional step allows for the rotation of the means to generate tracking spots by an amount determined by pre-stored settings obtained from calibration during manufacture. Such a step permits standardization of rotation for different optical recording devices, which are advantages in a high volume production environment.

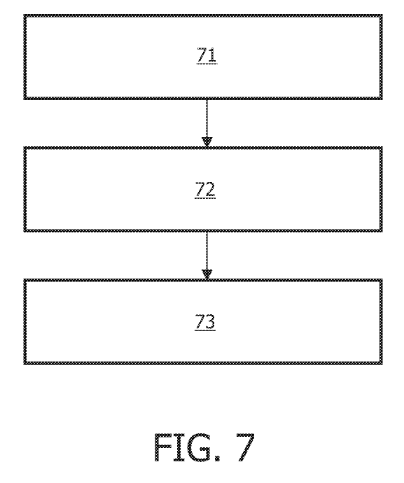

FIG. 7 illustrates a method for initial programming of an optical recording device according to the invention. This method comprises a step 71 of provision of a means to generate tracking spots arranged in cooperation with a means of rotation such that the means to generate tracking spots is rotatable between at least two positions. The method further comprises a step 72 of provision of a calibration source comprising at least one pre-determined setting for amount of rotation to be applied to the means of rotation. Another method step 73 comprises incorporation of the at least one pre-determined setting for amount of rotation into a non-volatile memory of the OPU or other memory component of the optical recording device. The method is flexible with respect to the number of rotations and settings which may be required for application to particular types of optical recording devices or application to particular types of optical record carriers, e.g. those with multiple data layers.

### LIST OF REFERENCE NUMERALS

11 optical record carrier
12 direction of spin of the optical record carrier
13 recorded track
14 unrecorded track
15 write spot
16 tracking spot
17 tracking spot
26 tracking spot
27 tracking spot
31 optical record carrier
32 unrecorded track
33 recorded track
46 tracking spot
47 tracking spot
51 to 54, 61, and 71 to 73: process steps in methods according to the invention

1. An optical recording device, for recording data on an optical record carrier comprising at least two layers comprising tracks for recording the data, the optical recording device comprising a light beam, and further comprising a means to generate tracking spots from the light beam to aid positioning of a write spot used to record data on the optical record carrier, characterized in that, the means to generate tracking spots is arranged to cooperate with a means for rotation such that the means to generate tracking spots is rotatable between at least two positions to achieve optimum orientation of tracking spots, such that each tracking spot is positioned between two neighboring tracks on the optical record carrier and is either adjacent on two sides to recorded tracks or adjacent on two sides to unrecorded tracks, for each layer to be recorded.

2. An optical recording device as claimed in claim 1, wherein the means to generate tracking spots comprises a grating.

3. An optical recording device as claimed in claim 2, wherein the grating is a three beam grating which produces three spots of light, namely one main spot and two satellite spots.

4. An optical recording device as claimed in claim 1, wherein the means to generate tracking spots forms part of a push pull tracking system.

5. An optical recording device as claimed in claim 1, wherein the means for rotation comprises a motor.

6. An optical recording device as claimed in claim 1, wherein the means for rotation comprises a piezo element.

7. A method of operating an optical recording device, in cooperation with an optical record carrier comprising at least two layers on which data may be recorded along tracks, comprising steps of:
Providing a means to generate tracking spots, arranged to cooperate with a means for rotation, such that the means to generate tracking spots is rotatable between at least two positions,
Operating the optical recording device in write mode to record data on a data layer,
If recording on a layer 1, positioning the means to generate tracking spots in accordance with an operation of writing data to a data layer, such that each tracking spot is positioned between two neighboring tracks on the optical record carrier, and is either adjacent on two sides to recorded tracks or adjacent on two sides to unrecorded tracks, and thereby giving at least a leading spot and a trailing spot with respect to a main write spot,
If recording on a layer 2, rotating of the means to generate tracking spots by the means for rotation to adjust the tracking spot position and is either adjacent on two sides to recorded tracks or adjacent on two sides to unrecorded tracks, and thereby giving at least a leading spot and a trailing spot with respect to the main write spot, such that the orientation of the leading spot for recording on layer 1 becomes the trailing spot for recording on layer 2 and visa versa, or,
if recording on layer 2, rotating of the means to generate tracking spots by the means for rotation to adjust the tracking spot position and is either adjacent on two sides to recorded tracks or adjacent on two sides to unrecorded tracks, and thereby giving at least a leading spot and a trailing spot with respect to the main write spot, such that the leading spot for recording on layer 1 remains the leading spot for recording on layer 2, and the trailing spot for recording on layer 1 remains the trailing spot for recording on layer 2.

8. A method of operating an optical recording device as claimed in claim 7, comprising the additional step of:
Rotating the means to generate tracking spots by an amount determined by pre-stored settings obtained from calibration during manufacture.

9. A method for initial programming of an optical recording device comprising an optical pickup unit (OPU) comprising steps of:
Provision of a means to generate tracking spots arranged in cooperation with a means of rotation such that the means to generate tracking spots is rotatable between at least two positions,
Provision of a calibration source comprising at least one pre-determined setting for amount of rotation to be applied to the means of rotation,
Incorporation of the at least one pre-determined setting for amount of rotation into a non-volatile memory of the OPU or other memory component of the optical recording device.
